(19) United States
(12) Patent Application Publication
(10) Pub. No.: US 2023/0196130 A1
(43) Pub. Date: Jun. 22, 2023

(54) SYSTEM AND METHOD OF EVALUATING AND ASSIGNING A QUANTITATIVE NUMBER FOR ASSETS IN CONNECTION WITH AN AUTONOMOUS VEHICLE

(71) Applicant: GM CRUISE HOLDINGS LLC, San Francisco, CA (US)

(72) Inventor: Ignacio Martin-Bragado, Mountain View, CA (US)

(21) Appl. No.: 17/553,955

(22) Filed: Dec. 17, 2021

(51) Int. Cl. G06N 5/02; G05D 1/00

(52) U.S. Cl. CPC G06N 5/022; G05D 1/0088; G05D 2201/0213

(57) ABSTRACT

Disclosed herein are systems and methods including a method for determining how real assets are in simulations of street scenes. The method includes generating a simulation in a meaningful way, the simulation having an asset, processing the simulation via a machine learning model, the machine learning model being trained to identify which classifications of assets are present in the simulation and output a quantitative number as a proxy for how real the asset would appear to a human viewer, determining, via the machine learning model, that the asset is a classification identified by the machine learning model and outputting, from the machine learning model, the quantitative number as the proxy for how real the asset would appear to the human viewer.

### FIELD OF THE DISCLOSURE

The present disclosure relates to autonomous vehicles (AVs) and furthermore to an approach to evaluating assets in a detection category relative to other assets in the same category to establish a quantitative quality number for each asset.

### INTRODUCTION

Autonomous vehicles (AVs) at least to some degree are starting to appear in our economy. In some cases, an AV includes sensors that enable it to determine whether other vehicles or objects are in its way. When evaluating the environment around an AV, cameras or other sensors will sense object in the environment. Cars, people, bicycles, animals and so forth can be seen or viewed by a sensor and are called assets. The system may put a “box” around an object or an item as it seeks to determine what it is, how it is moving so forth. In some cases, companies may use simulations of street scenes to help to operate or train the AV to go to the right route and avoid collisions.

A challenge exists where in some cases the system may classify objects as people, animals, cars, and so forth but the system may classify the object incorrectly or simulate the assets with more or less realism. The system may use detected object data to generate a simulation of the environment and the objects that might be seen by the AV.

Simulating reality is difficult. Assets in a scene such as a car, bike, plant or any other object (asset) that can be presented from models via the simulator. Different models can be used to generate such assets in a simulation. Simulation models cannot cover all possible scenarios. For example, the system may have 100 car simulation models and then can model other features such as a convertible top and a color of the vehicle. When a simulation is generated via the use of such models however, the asset (car) may not ultimately look that real. There is no mechanism currently to evaluate at what level or how good is the simulation of assets as a representation of reality.

### BRIEF DESCRIPTION OF THE FIGURES

Illustrative embodiments of the present application are described in detail below with reference to the following figures:

FIG. 1 illustrates an example of a system for managing one or more Autonomous Vehicles (AVs) in accordance with some aspects of the present technology;

FIG. 2 illustrates an example environment which can be detected and classified by a system which data can then be used to generate a synthetic environment;

FIGS. 3A-B illustrates how objects can be determined to be connected and thus a quantitative number associated with “realism” can be assigned;

FIG. 4 illustrates an example method; and

FIG. 5 illustrates a computing device which can be used in the various examples disclosed herein.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the application as set forth in the appended claims.

### BRIEF INTRODUCTION OF THE DISCLOSURE

This disclosure focuses on how to determine whether an asset such as a car, tree or person which is presented in a simulation looks sufficiently real. For example, a simulation might be generated of a street which can include cars, people and motorcycles. The simulated data will have varying degrees to which it would appear real to a person. In some cases, the colors, the shading, the shape, or other details might not look that real to a human user that would be viewing the simulation. In this scenario, an “asset” would be any object which is simulated in the scene.

Disclosed herein are systems and methods including a method for determining how real assets are in simulations of street scenes. The disclosed process includes using an output of a machine learning model that classifies the assets in the simulation as a proxy for “realism” or how real the asset may look to a person who would be viewing the simulation. The method includes generating a simulation of a physical scene, the simulation having an asset or several assets repeated with different configurations, processing the simulation via a machine learning model, the machine learning model being trained to identify which classifications of assets are present in the simulation and output a quantitative number as a proxy for how real the asset would appear to a human viewer, determining, via the machine learning model, that the asset is a classification identified by the machine learning model and outputting, from the machine learning model, the quantitative number as the proxy for how real the asset would appear to the human viewer. In one aspect, the machine learning model is trained on real assets such as real cars, people, bicycles and so forth.

The machine learning model will then evaluate the various assets in the simulation and its output will represent the quantitative number which can relate to how closely the machine learning model matches the simulated asset. For example, if the asset is a car such as a BMW Mini Cooper and the machine learning model is trained on BMW Mini Coopers, the simulation of the BMW Mini Cooper might be very close to actual BMW Mini Cooper. The confidence level of the machine learning model might be high, such as 0.9 on a scale of 0 to 1. What this could mean is that the simulation of the Mini as an asset can be very good or very close to “realism” in that a person viewing the simulation would consider it very close to a real car. In such a case, the asset in the simulation can remain and not be altered or removed. However, if the output of the machine learning model is a 0.2, the confidence level or the realism of the asset might be quite low. When the confidence level is low or below a threshold, that means that the asset does not look very real in the simulation. The system in this case may exchange the asset (a Mini) with a more realistic-looking Mini or choose a different model (perhaps inserting a model of a Fiat) to use as the basis for the simulation of the car and try again to assess how realistic the new asset is via the machine learning model.

Any scale can be used and the example of a range of 0 to 1 is only provided by way of example. The range can be from 0 to 10 or from 0 to 100 or any other range which is workable.

A system can include a processor and a computer-readable storage device storing instructions which, when executed by the processor, cause the processor to perform operations including generating a simulation of a physical scene, the simulation having an asset, processing the simulation via a machine learning model, the machine learning model being trained to identify which classifications of assets are present in the simulation and output a quantitative number as a proxy for how real the asset would appear to a human viewer, determining, via the machine learning model, that the asset is a classification identified by the machine learning model and outputting, from the machine learning model, the quantitative number as the proxy for how real the asset would appear to the human viewer.

### DETAILED DESCRIPTION OF THE DISCLOSURE

The present disclosure addresses the problem with respect to how accurate and real are simulated assets within a scene that can be used in some aspect to enable an autonomous vehicle (AV) to properly and safely travel along a road. This disclosure primarily focuses on a machine learning model technique for evaluating and classifying assets presented in a simulation that uses models to generate the assets.

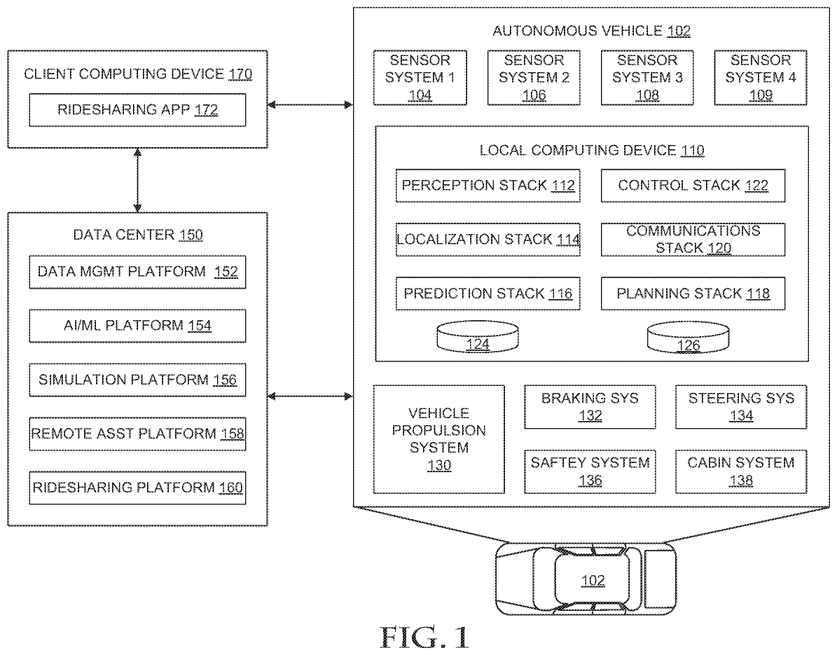

Inasmuch as data which can be used to train the machine learning model or the ultimate use of the data obtained herein with respect to how real an asset is in a simulation can relate to the use of AVs, FIG. 1 is presented first which discusses various aspects of AVs. The AV in FIG. 1 might be used to generate on-road data for use in training the machine learning model disclosed herein or it might have other machine learning or other models that utilize improved simulation data as is describe herein.

FIG. 1 illustrates an example of an AV management system 100. One of ordinary skill in the art will understand that, for the AV management system 100 and any system discussed in the present disclosure, there can be additional or fewer components in similar or alternative configurations. The illustrations and examples provided in the present disclosure are for conciseness and clarity. Other embodiments may include different numbers and/or types of elements, but one of ordinary skill the art will appreciate that such variations do not depart from the scope of the present disclosure.

In this example, the AV management system 100 includes an autonomous vehicle (AV) 102, a data center 150, and a client computing device 170. The AV 102, the data center 150, and the client computing device 170 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

The AV 102 can navigate roadways without a human driver based on sensor signals generated by multiple sensor systems 104, 106, 108 and 109. The sensor systems 104-109 can include different types of sensors and can be arranged about the AV 102. For instance, the sensor systems 104-109 can comprise Inertial Measurement Units (IMUs), cameras (e.g., still image cameras, video cameras, etc.), light sensors (e.g., LIDAR systems, ambient light sensors, infrared sensors, etc.), RADAR systems, GPS receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 104 can be a camera system, the sensor system 106 can be a LIDAR system, and the sensor system 108 can be a RADAR system. Sensor system 109 can be a different type of sensor such as a camera. Other embodiments may include any other number and type of sensors. The sensors can be used in one aspect to generate real on-road data that is used to train the machine learning models disclosed herein which can aid in outputting a quantitative number identifying how real a modeled asset looks in a simulation.

The AV 102 can also include several mechanical systems that can be used to maneuver or operate the AV 102. For instance, the mechanical systems can include a vehicle propulsion system 130, a braking system 132, a steering system 134, a safety system 136, and a cabin system 138, among other systems. The vehicle propulsion system 130 can include an electric motor, an internal combustion engine, or both. The braking system 132 can include an engine brake, brake pads, actuators, and/or any other suitable componentry configured to assist in decelerating the AV 102. The steering system 134 can include suitable componentry configured to control the direction of movement of the AV 102 during navigation. The safety system 136 can include lights and signal indicators, a parking brake, airbags, and so forth. The cabin system 138 can include cabin temperature control systems, in-cabin entertainment systems, and so forth. In some embodiments, the AV 102 might not include human driver actuators (e.g., steering wheel, handbrake, foot brake pedal, foot accelerator pedal, turn signal lever, window wipers, etc.) for controlling the AV 102. Instead, the cabin system 138 can include one or more client interfaces (e.g., Graphical User Interfaces (GUIs), Voice User Interfaces (VUIs), etc.) for controlling certain aspects of the mechanical systems 130-138.

The AV 102 can additionally include a local computing device 110 that is in communication with the sensor systems 104-109, the mechanical systems 130-138, the data center 150, and the client computing device 170, among other systems. The local computing device 110 can include one or more processors and memory, including instructions that can be executed by the one or more processors. The instructions can make up one or more software stacks or components responsible for controlling the AV 102; communicating with the data center 150, the client computing device 170, and other systems; receiving inputs from riders, passengers, and other entities within the AV's environment; logging metrics collected by the sensor systems 104-109; and so forth. In this example, the local computing device 110 includes a perception stack 112, a mapping and localization stack 114, a prediction stack 116, a planning stack 118, a communications stack 120, a control stack 122, an AV operational database 124, and an HD geospatial database 126, among other stacks and systems.

The perception stack 112 can enable the AV 102 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 104-109, the mapping and localization stack 114, the HD geospatial database 126, other components of the AV, and other data sources (e.g., the data center 150, the client computing device 170, third party data sources, etc.). The perception stack 112 can detect and classify objects and determine their current locations, speeds, directions, and the like. In addition, the perception stack 112 can determine the free space around the AV 102 (e.g., to maintain a safe distance from other objects, change lanes, park the AV, etc.). The perception stack 112 can also identify environmental uncertainties, such as where to look for moving objects, flag areas that may be obscured or blocked from view, and so forth. In some embodiments, an output of the prediction stack can be a bounding area around a perceived object that can be associated with a semantic label that identifies the type of object that is within the bounding area, the kinematic of the object (information about its movement), a tracked path of the object, and a description of the pose of the object (its orientation or heading, etc.).

The mapping and localization stack 114 can determine the AV's position and orientation (pose) using different methods from multiple systems (e.g., GPS, IMUs, cameras, LIDAR, RADAR, ultrasonic sensors, the HD geospatial database 122, etc.). For example, in some embodiments, the AV 102 can compare sensor data captured in real-time by the sensor systems 104-109 to data in the HD geospatial database 126 to determine its precise (e.g., accurate to the order of a few centimeters or less) position and orientation. The AV 102 can focus its search based on sensor data from one or more first sensor systems (e.g., GPS) by matching sensor data from one or more second sensor systems (e.g., LIDAR). If the mapping and localization information from one system is unavailable, the AV 102 can use mapping and localization information from a redundant system and/or from remote data sources.

The prediction stack 116 can receive information from the localization stack 114 and objects identified by the perception stack 112 and predict a future path for the objects. In some embodiments, the prediction stack 116 can output several likely paths that an object is predicted to take along with a probability associated with each path. For each predicted path, the prediction stack 116 can also output a range of points along the path corresponding to a predicted location of the object along the path at future time intervals along with an expected error value for each of the points that indicates a probabilistic deviation from that point.

The planning stack 118 can determine how to maneuver or operate the AV 102 safely and efficiently in its environment. For example, the planning stack 116 can receive the location, speed, and direction of the AV 102, geospatial data, data regarding objects sharing the road with the AV 102 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 102 from one point to another and outputs from the perception stack 112, localization stack 114, and prediction stack 116. The planning stack 118 can determine multiple sets of one or more mechanical operations that the AV 102 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 118 can select from multiple backup plans to carry out. For example, while preparing to change lanes to turn right at an intersection, another vehicle may aggressively cut into the destination lane, making the lane change unsafe. The planning stack 118 could have already determined an alternative plan for such an event. Upon its occurrence, it could help direct the AV 102 to go around the block instead of blocking a current lane while waiting for an opening to change lanes.

The control stack 122 can manage the operation of the vehicle propulsion system 130, the braking system 132, the steering system 134, the safety system 136, and the cabin system 138. The control stack 122 can receive sensor signals from the sensor systems 104-109 as well as communicate with other stacks or components of the local computing device 110 or a remote system (e.g., the data center 150) to effectuate operation of the AV 102. For example, the control stack 122 can implement the final path or actions from the multiple paths or actions provided by the planning stack 118. This can involve turning the routes and decisions from the planning stack 118 into commands for the actuators that control the AV's steering, throttle, brake, and drive unit.

The communication stack 120 can transmit and receive signals between the various stacks and other components of the AV 102 and between the AV 102, the data center 150, the client computing device 170, and other remote systems. The communication stack 120 can enable the local computing device 110 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). The communication stack 120 can also facilitate the local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Bluetooth®, infrared, etc.).

The HD geospatial database 126 can store HD maps and related data of the streets upon which the AV 102 travels. In some embodiments, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include 3D attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal u-turn lanes; permissive or protected only right turn lanes; etc.). The traffic controls lane can include geospatial information of traffic signal lights, traffic signs, and other road objects and related attributes.

The AV operational database 124 can store raw AV data generated by the sensor systems 104-109, stacks 112-122, and other components of the AV 102 and/or data received by the AV 102 from remote systems (e.g., the data center 150, the client computing device 170, etc.). In some embodiments, the raw AV data can include HD LIDAR point cloud data, image data, RADAR data, GPS data, and other sensor data that the data center 150 can use for creating or updating AV geospatial data or for creating simulations of situations encountered by AV 102 for future testing or training of various machine learning algorithms that are incorporated in the local computing device 110.

The data center 150 can be a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and so forth. The data center 150 can include one or more computing devices remote to the local computing device 110 for managing a fleet of AVs and AV-related services. For example, in addition to managing the AV 102, the data center 150 may also support a ridesharing service, a delivery service, a remote/roadside assistance service, street services (e.g., street mapping, street patrol, street cleaning, street metering, parking reservation, etc.), and the like.

The data center 150 can send and receive various signals to and from the AV 102 and the client computing device 170. These signals can include sensor data captured by the sensor systems 104-109, roadside assistance requests, software updates, ridesharing pick-up and drop-off instructions, and so forth. In this example, the data center 150 includes a data management platform 152, an Artificial Intelligence/Machine Learning (AI/ML) platform 154, a simulation platform 156, a remote assistance platform 158, and a ridesharing platform 160, among other systems.

The data management platform 152 can be a “big data” system capable of receiving and transmitting data at high velocities (e.g., near real-time or real-time), processing a large variety of data and storing large volumes of data (e.g., terabytes, petabytes, or more of data). The varieties of data can include data having different structured (e.g., structured, semi-structured, unstructured, etc.), data of different types (e.g., sensor data, mechanical system data, ridesharing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), or data having other heterogeneous characteristics. The various platforms and systems of the data center 150 can access data stored by the data management platform 152 to provide their respective services.

The AI/ML platform 154 can provide the infrastructure for training and evaluating machine learning algorithms for operating the AV 102, the simulation platform 156, the remote assistance platform 158, the ridesharing platform 160, the cartography platform 162, and other platforms and systems. Using the AI/ML platform 154, data scientists can prepare data sets from the data management platform 152; select, design, and train machine learning models; evaluate, refine, and deploy the models; maintain, monitor, and retrain the models; and so on. Note that the AI/ML platform 154 can be the same or different from the machine learning models described below to evaluate assets in simulations for how real they look.

The simulation platform 156 can enable testing and validation of the algorithms, machine learning models, neural networks, and other development efforts for the AV 102, the remote assistance platform 158, the ridesharing platform 160, the cartography platform 162, and other platforms and systems. The simulation platform 156 can replicate a variety of driving environments and/or reproduce real-world scenarios from data captured by the AV 102, including rendering geospatial information and road infrastructure (e.g., streets, lanes, crosswalks, traffic lights, stop signs, etc.) obtained from the cartography platform 162; modeling the behavior of other vehicles, bicycles, pedestrians, and other dynamic elements; simulating inclement weather conditions, different traffic scenarios; and so on. As the present disclosure relates to how to improve simulations using the machine learning model disclosed herein, the principles can be included in or improve the simulation platform 156 disclosed in FIG. 1.

The remote assistance platform 158 can generate and transmit instructions regarding the operation of the AV 102. For example, in response to an output of the AI/ML platform 154 or other system of the data center 150, the remote assistance platform 158 can prepare instructions for one or more stacks or other components of the AV 102.

The ridesharing platform 160 can interact with a customer of a ridesharing service via a ridesharing application 172 executing on the client computing device 170. The client computing device 170 can be any type of computing system, including a server, desktop computer, laptop, tablet, smartphone, smart wearable device (e.g., smartwatch, smart eyeglasses or other Head-Mounted Display (HMD), smart ear pods, or other smart in-ear, on-ear, or over-ear device, etc.), gaming system, or other general purpose computing device for accessing the ridesharing application 172. The client computing device 170 can be a customer's mobile computing device or a computing device integrated with the AV 102 (e.g., the local computing device 110). The ridesharing platform 160 can receive requests to pick up or drop off from the ridesharing application 172 and dispatch the AV 102 for the trip.

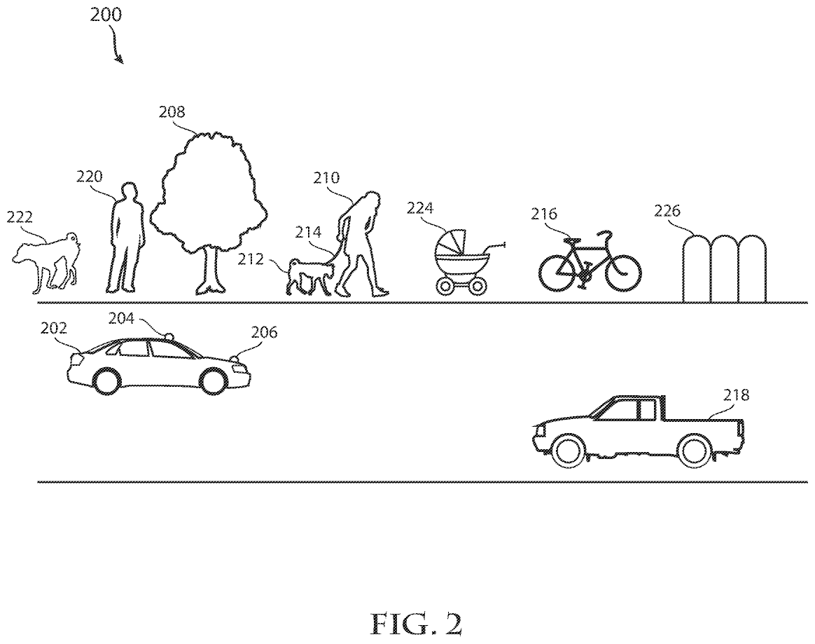

This disclosure now turns to the details which are the focus of this application and which involve using a machine learning model to evaluate and quantify how good assets are in a simulation, particularly in terms of how real they look. FIG. 2 illustrates an example simulation 200 of a scene which can include various assets such as a car 206, another vehicle 218, an animal 222, a person 220, a tree 208, a second person 210, a dog 212 having a leash 214, a stroller 224, a bicycle 216 and a bike rack 226. Each asset may be generated from a computer model that has data such as size, shape, color, and so forth that can be translated into visual data that can be seen in a simulation. The vehicle 202 can also represent a real vehicle that can have a first sensor like a camera 202 and a second sensor like a LIDAR 204. Some of the data used for simulation might come from such sensors or may be purely generated data by a computer system via various models.

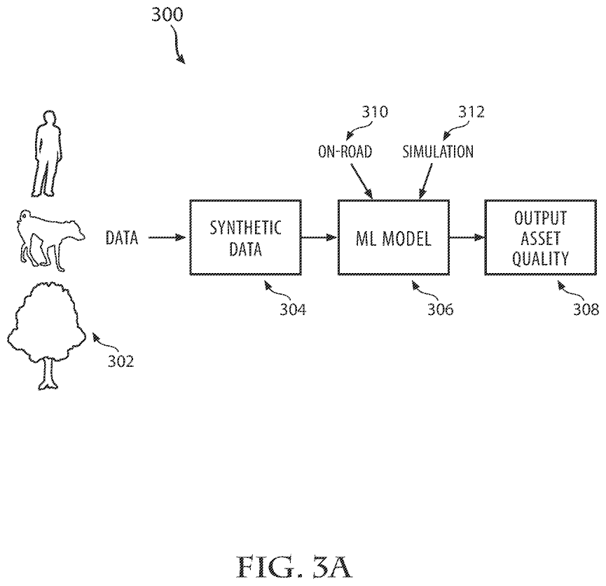

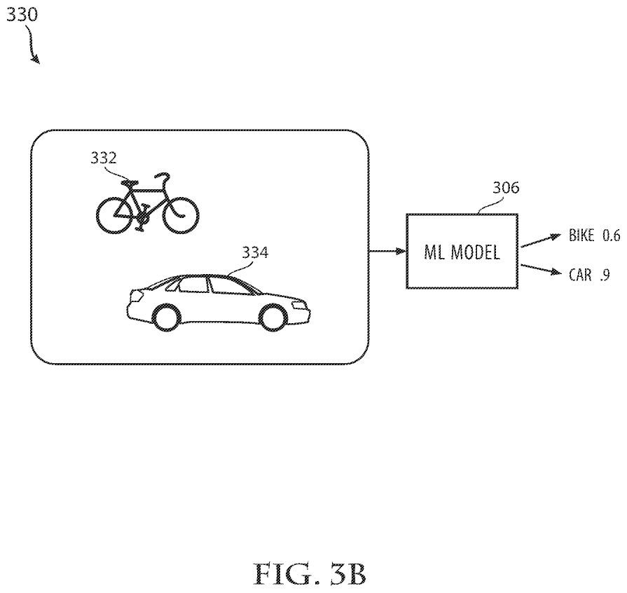

FIG. 3A illustrates some of the basic operations 300 of this disclosure. Data 302 such as data about trees, cars and people is provided to a simulator to generate a simulation 304. The data 302 can represent various models of the different assets. The system can for example select a certain model for a tree, and a certain model for an animal, person or car. The simulation can be of a street scene in which assets (the various objects in a scene) move or are presented in the simulation. The simulations can be used by companies that build autonomous vehicles such as is shown in FIG. 1. The issue is therefore how good the simulation is relative to real life and how an asset might look to a hyman viewer. How close to real life are the assets presented. The asset may vary with respect to its color, the light reflection, the orientation, the movement, and so forth. It can be very expensive for a person to actually view the simulation and make manual judgements on how real each asset looks. This disclosure addresses this issue by introducing a machine learning model 306 that is trained either with real data (on-road) data 310 or simulated data 312. If the ML model is trained on simulated data 312, then the output won't necessarily be a representation of how real the data is but rather how good the simulation is relative to the simulation data or the simulation data associated with the machine learning model. When the machine learning model 306 is trained on real data (real cars, real motorcycles, etc.), then it can be used to obtain a value that relates to whether the asset represents a real object. The output of the machine learning model 306 might include a level of confidence or a value that indicates how close the simulation asset is to the real asset as represented by the machine learning model 306.

FIG. 3B illustrates a simulated image 330 which has a bike 332 and a car 334. These can be generated via the use of models generated from the data 302 used as the basis for the simulation. The models can be then translated into synthetic data for the simulation 330 of assets in a scene.

The machine learning model 306 can first determine whether classified assets are present. In this case, the machine learning model 306 might identify a car 334 and a bike 332 as shown in the simulation 330. The machine learning model can be trained on real or simulated data to recognize the asset in the scene. Such a recognition can be binary however such as determining with an output of a 0 if there is no asset or a 1 confirming the decision that there is a bike 332 or a car 334 in the scene. Next, a quantitative value can be assigned to each asset which is a representation of how real the asset looks or would look to a human viewer. The value can actually simply be a value representing how close the simulated asset is to a real asset and thus the value can be a proxy for how “real” the simulation is. For this reason, it is preferable that the machine learning model be trained on real object or via on-road gathering of data. In FIG. 3B, the example data is 0.6 for the bike and 0.9 for the car. This data can represent a quantitative value which represents how closely the simulated asset is to “realism”. In other words, at a top end of the scale (say a 1) could be a “perfect” or pure match in which the simulated asset looks completely real to a human. A 0.9 value would be close and might meet a threshold level for keeping the simulated data for the asset. For example, if the threshold value is 0.7 and any output of the machine learning model 306 equal to or above 0.7 might indicate a sufficient level of realism. A 0.6 value might indicate less confidence or less realism in the asset image. The system may in this case replace the simulated asset with more real data to improve how the asset would look to a person in the simulation.

The goal of this disclosure is to obtain a quantitative number of the “realism” for each asset in a given classification. Realism is hard to define and therefore, the output of the machine learning model is a proxy measure of realism. The proxy represents how well each asset is detected by the machine learning model 306 that has been trained in the real world, i.e., on the road. This disclosure implements the following flow: A system can define a special scenario in a city emptied, as much as possible, from other objects. For each asset in a category or classification, the system can include it into the scenario and at different distances and orientations, so that different facets of the same asset will all be seen. The system can run the synthetic data generation on each of these scenes created. Once the scenes are generated, the system can use the machine learning road model 306 to perceive which classifications (assets) are present in the scenes, and evaluates if the perceived classifications (output) are the same as the expected ones (input). The system can use the input/output metrics to produce tables that display the relative quality for each asset in a given classification.

A novel feature disclosed herein include the definition of a proxy for realism by using road perception and the automatic creation of scenarios that allow an “apples-to-apples” comparison of each asset with the others. The system implements different paths to evaluate the assets, depending on the models involved.

In one example, a synthetic car 334 could be in a scene with a certain color of blue. The machine learning model 306 could be trained on real cars and include real cars that are painted blue. In one aspect, the output of the machine learning model could indicate that there is a low quantitative number or value for the simulated asset. This could mean that the color of the simulated car was not representative of the real world to a very high level. The system could then determine not to use the blue color on the simulation and use a blue color that is more realistic and what people would actually see on the road. The machine learning model 306 can include various aspects of the assets so that the one model can recognize what the asset is (a car), the color, the size, how it moves, and so forth.

In one aspect, the system might maintain a background image for a number of different assets that are tested by the machine learning model 306. In another aspect the system might present rotated assets or re-arranged assets and send them through the machine learning model 306. In this regard, one angle of an asset might look more real than another view or angle of an asset. The system might test 100 assets and only 60 assets might have outputs from the machine learning model 306 that are above a threshold and thus are sufficiently “real.” The system may then just use those 60 or might cause the system or a user to revise or improve the other 40 assets that were not sufficiently “real”.

In one example, the system will create scenarios where assets can be placed in. For example, the system can select a clean road, or may add traffic lights and plants. Then, in the scene or the context of a simulation, the system can then add a simulated asset, generated from a model, such as a model for a car. In the simulation, the system can control such things as lighting, the position of objects, color, and so forth. An asset can be run through multiple scenarios related to different times of day, illumination, position, movement, cornering, walking style for a person, rotations, difference from a camera or a LIDAR system, and so forth. Thus, in one aspect, an “apples-to-apples” comparison can include running an asset (like a car) through a context or a scene and then processing the scene with the respective asset through the machine learning model 306 to get a more direct comparisons of different assets that might be of a same type.

In this regard, through a single arranged scene, the system might run for example 100 cars through the scene and get a comparable view of how “real” each of the cars is in an “apple-to-apple” comparison which simply compares the assets in the same background or lighting condition.

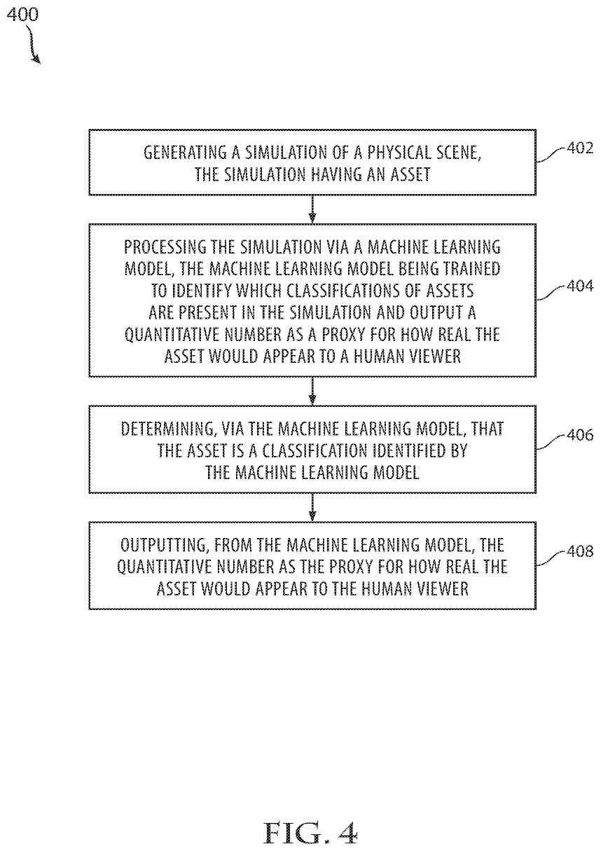

FIG. 4 illustrates an example method 400 of how to provide a quantitative number as a proxy for how realistic an asset looks. The method 400 includes generating a simulation of a physical scene, the simulation having an asset (402), processing the simulation via a machine learning model, the machine learning model being trained to identify which classifications of assets are present in the simulation and output a quantitative number as a proxy for how real the asset would appear to a human viewer (404), determining, via the machine learning model, that the asset is a classification identified by the machine learning model (406) and outputting, from the machine learning model, the quantitative number as the proxy for how real the asset would appear to the human viewer (408). In one aspect, the machine learning model is trained on real assets such as real cars, people, bicycles and so forth.

The machine learning model will then evaluate the various assets in the simulation and its output will represent the quantitative number which can relate to how closely the machine learning model matches the simulated asset. For example, if the asset is a car such as a BMW Mini Cooper and the machine learning model is trained on BMW Mini Coopers, the simulation of the BMW Mini Cooper might be very close to actual BMW Mini Cooper. The confidence level of the machine learning model might be high, such as 0.9 on a scale of 0 to 1. What this could mean is that the simulation of the Mini as an asset can be very good or very close to “realism” in that a person viewing the simulation would consider it very close to a real car. In such a case, the asset in the simulation can remain and not be altered or removed. However, if the output of the machine learning model is a 0.2, the confidence level or the realism of the asset might be quite low, and the system may exchange a more realistic Mini (such as choosing a different Mini model) for the asset in the simulation.

A system can include a processor and a computer-readable storage device storing instructions which, when executed by the processor, cause the processor to perform operations including generating a simulation of a physical scene, the simulation having an asset, processing the simulation via a machine learning model, the machine learning model being trained to identify which classifications of assets are present in the simulation and output a quantitative number as a proxy for how real the asset would appear to a human viewer, determining, via the machine learning model, that the asset is a classification identified by the machine learning model and outputting, from the machine learning model, the quantitative number as the proxy for how real the asset would appear to the human viewer.

The machine learning model can be trained either on simulated data or from on-road data. A vehicle similar to what is shown in FIG. 1 can be used with various sensors to gather data for use in the simulation. The asset can include a car, a person, a bicycle, a motorcycle, a person or an animal. Any other object which might be in a road or in the scene can be an asset, such as a plane, helicopter, drone, plant, building, and so forth.

As noted above, the quantitative number can represent how confident the machine learning model is with respect to an identification of an asset. In another aspect, the quantitative number can be more generally related to the output of the machine learning model 306 and not be tied to its confidence level.

The method can further include, when the quantitative value equals at least a threshold value, using the asset in the simulation for managing routes for an autonomous vehicle (AV) 102.

In another aspect, when the quantitative value does not equal or is below the threshold value, the method can include replacing the asset in the simulation with different data for use in managing routes for an AV 102.

The step of generating the simulation of a physical scene further can include running the simulation multiple times in connection with the asset with different contexts and then applying the machine learning model to each respective simulation of multiple simulations in different contexts. For example, different light sources (noon-day sun, or morning/evening sun, cloudy sky, and so forth) can be used in different simulations to generate different outcomes. The different contexts relate to one or more of light source, color, motion, speed, direction, orientation, probable orientation/occlusion, rotation, possible overlapping/occlusion and distance from the asset to a sensor.

The quantitative number as the proxy for how real the asset would appear to the human viewer can relate as noted above to a confidence level associated with the output from the machine learning model 306.

When the quantitative number reaches a threshold value, then the method can include maintaining the asset in the simulation and when the quantitative number does not reach the threshold value, then replacing the asset in the simulation with new data to represent the asset.

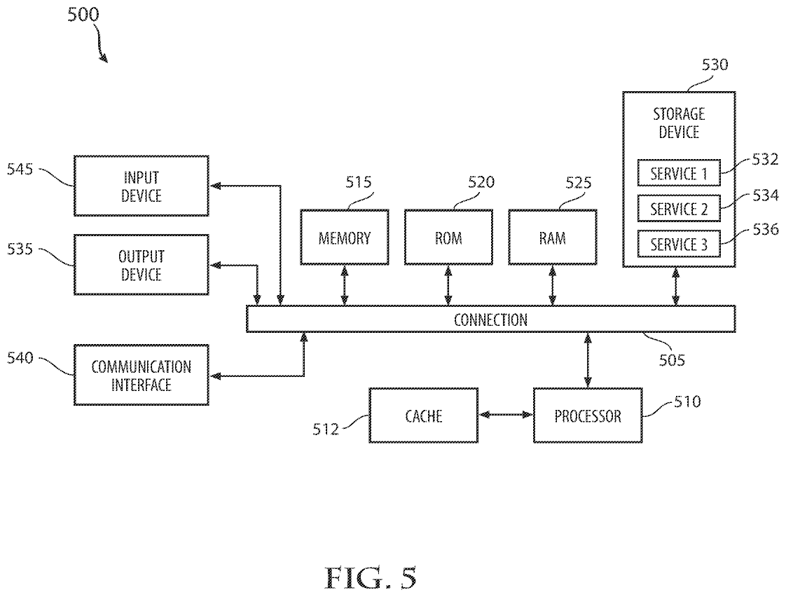

FIG. 5 illustrates an architecture of an example computing device 500 which can implement the various techniques described herein. For example, the computing device 500 can implement the autolabeler module 502 shown in FIG. 5. The components of the computing device 500 are shown in electrical communication with each other using a connection 505, such as a bus. The example computing device 500 includes a processing unit (CPU or processor) 510 and a computing device connection 505 that couples various computing device components including the computing device memory 515, such as read-only memory (ROM) 520 and random access memory (RAM) 525, to the processor 510. The computing device 500 can include a cache of high-speed memory connected directly with, in close proximity to, or integrated as part of the processor 510. The computing device 500 can copy data from the memory 515 and/or the storage device 530 to the cache 512 for quick access by the processor 510. In this way, the cache can provide a performance boost that avoids processor 510 delays while waiting for data. These and other modules can control or be configured to control the processor 510 to perform various actions.

Other computing device memory 515 may be available for use as well. The memory 515 can include multiple different types of memory with different performance characteristics. The processor 510 can include any general purpose processor and hardware or software service, such as service 1 532, service 2 534, and service 3 536 stored in storage device 530, configured to control the processor 510 as well as a special-purpose processor where software instructions are incorporated into the processor design. The processor 510 may be a self-contained system, containing multiple cores or processors, a bus, memory controller, cache, etc. A multi-core processor may be symmetric or asymmetric.

To enable user interaction with the computing device 500, an input device 545 can represent any number of input mechanisms, such as a microphone for speech, a touch-sensitive screen for gesture or graphical input, keyboard, mouse, motion input, speech and so forth. An output device 535 can also be one or more of a number of output mechanisms known to those of skill in the art, such as a display, projector, television, speaker device, etc. In some instances, multimodal computing devices can enable a user to provide multiple types of input to communicate with the computing device 500. The communications interface 540 can generally govern and manage the user input and computing device output. There is no restriction on operating on any particular hardware arrangement and therefore the basic features here may easily be substituted for improved hardware or firmware arrangements as they are developed.

Storage device 530 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 525, read only memory (ROM) 520, and hybrids thereof.

The storage device 530 can include services 532, 534, 536 for controlling the processor 510. Other hardware or software modules are contemplated. The storage device 530 can be connected to the computing device connection 505. In one aspect, a hardware module that performs a particular function can include the software component stored in a computer-readable medium in connection with the necessary hardware components, such as the processor 510, connection 505, output device 535, and so forth, to carry out the function.

For clarity of explanation, in some instances, the present technology may be presented as including individual functional blocks including functional blocks comprising devices, device components, steps or routines in a method embodied in software, or combinations of hardware and software.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods, according to the above-described examples, can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can include hardware, firmware and/or software, and can take any of a variety of form factors. Typical examples of such form factors include laptops, smart phones, small form factor personal computers, personal digital assistants, rackmount devices, standalone devices, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components, computing devices and methods within the scope of the appended claims.

Claim language reciting “at least one of” a set indicates that one member of the set or multiple members of the set satisfy the claim. For example, claim language reciting “at least one of A and B” means A, B, or A and B.

1. A method comprising:
generating a simulation of a physical scene, the simulation having an asset;
processing the simulation via a machine learning model, the machine learning model being trained to identify which classifications of assets are present in the simulation and output a quantitative number as a proxy for how real the asset would appear to a human viewer;
determining, via the machine learning model, that the asset is a classification identified by the machine learning model; and
outputting, from the machine learning model, the quantitative number as the proxy for how real the asset would appear to the human viewer.

2. The method of claim 1, wherein the machine learning model is trained either on simulated data or from on-road data.

3. The method of claim 1, wherein the asset comprises a car, a person, a bicycle, a motorcycle, a person or an animal.

4. The method of claim 1, wherein the quantitative number represents how confident the machine learning model is with respect to an identification of an asset.

5. The method of claim 1, further comprising:
when the quantitative value equals at least a threshold value, using the asset in the simulation for managing routes for an autonomous vehicle.

6. The method of claim 5, wherein when the quantitative value does not equal or is below the threshold value, replacing the asset in the simulation with different data for use in managing routes for an autonomous vehicle.

7. The method of claim 1, wherein generating the simulation of a physical scene further comprises running the simulation multiple times in connection with the asset with different contexts and then applying the machine learning model to each respective simulation of multiple simulations in different contexts.

8. The method of claim 7, wherein the different contexts relate to one or more of light source, color, motion, speed, direction, orientation, probable orientation/occlusion, rotation, possible overlapping/occlusion and distance from the asset to a sensor.

9. The method of claim 1, wherein the quantitative number as the proxy for how real the asset would appear to the human viewer relates to a confidence level associated with the output from the machine learning model.

10. The method of claim 1, wherein when the quantitative number reaches a threshold value, then maintaining the asset in the simulation and when the quantitative number does not reach the threshold value, then replacing the asset in the simulation with new data to represent the asset.

11. A system comprising:
a processor; and
a computer-readable storage device storing instructions which, when executed by the processor, cause the processor to perform operations comprising:
generating a simulation of a physical scene, the simulation having an asset;
processing the simulation via a machine learning model, the machine learning model being trained to identify which classifications of assets are present in the simulation and output a quantitative number as a proxy for how real the asset would appear to a human viewer;
determining, via the machine learning model, that the asset is a classification identified by the machine learning model; and
outputting, from the machine learning model, the quantitative number as the proxy for how real the asset would appear to the human viewer.

12. The system of claim 11, wherein the machine learning model is trained either on simulated data or from on-road data.

13. The system of claim 11, wherein the asset comprises a car, a person, a bicycle, a motorcycle, a person or an animal.

14. The system of claim 11, wherein the quantitative number represents how confident the machine learning model is with respect to an identification of an asset.

15. The system of claim 11, further comprising:
when the quantitative value equals at least a threshold value, using the asset in the simulation for managing routes for an autonomous vehicle.

16. The system of claim 15, wherein when the quantitative value does not equal or is below the threshold value, replacing the asset in the simulation with different data for use in managing routes for an autonomous vehicle.

17. The system of claim 11, wherein generating the simulation of a physical scene further comprises running the simulation multiple times in connection with the asset with different contexts and then applying the machine learning model to each respective simulation of multiple simulations in different contexts.

18. The system of claim 17, wherein the different contexts relate to one or more of light source, color, motion, speed, direction, orientation, probable orientation/occlusion, rotation, possible overlapping/occlusion and distance from the asset to a sensor.

19. The system of claim 11, wherein the quantitative number as the proxy for how real the asset would appear to the human viewer relates to a confidence level associated with the output from the machine learning model.

20. The system of claim 11, wherein when the quantitative number reaches a threshold value, then maintaining the asset in the simulation and when the quantitative number does not reach the threshold value, then replacing the asset in the simulation with new data to represent the asset.

21. A non-transitory computer-readable storage medium storing instructions which, when executed by a computing device having configured thereon a machine learning model trained to identify which classifications of assets are present in a simulation and output a quantitative number as a proxy for how real an asset would appear to a human viewer, cause the computing device to perform operations comprising:
generating a simulation of a physical scene, the simulation having an asset;
processing the simulation via the machine learning model;
determining, via the machine learning model, that the asset corresponds to a classification identified by the machine learning model; and
outputting, from the machine learning model, the quantitative number as the proxy for how real the asset would appear to the human viewer.
